(19) United States
(12) Patent Application Publication
(10) Pub. No.: US 2014/0067682 A1
(43) Pub. Date: Mar. 6, 2014

(54) NFC-BASED INFORMATION EXCHANGE METHOD AND DEVICE

(71) Applicant: Tencent Technology (Shenzhen) Company Limited., Shenzhen (CN)

(72) Inventor: Jiashun SONG, Shenzhen (CN)

(73) Assignee: Tencent Technology (Shenzhen) Company Limited., Shenzhen (CN)

(21) Appl. No.: 14/074,473

(22) Filed: Nov. 7, 2013

Related U.S. Application Data
(63) Continuation of application No. PCT/CN2013/081499, filed on Aug. 14, 2013.

(30) Foreign Application Priority Data
Aug. 15, 2012 (CN) 201210290523.5

(51) Int. Cl. H04L 29/06; G06Q 20/32

(52) U.S. Cl. CPC H04L 63/08; G06Q 20/3227
USPC 705/44; 726/3

(57) ABSTRACT

The present invention discloses a Near-Field-Communication (NFC)-based information exchange method and device. The method comprises: in response to an information reading request from an NFC scanning device, detecting whether the NFC scanning device works properly; performing security examination on the mobile terminal when the NFC scanning device works properly; acquiring contextual information associated with the information reading request after completing the security examination; choosing one of pre-set risk levels for the information reading request based on the contextual information; selecting an authentication method corresponding to the chosen risk level; prompting a user of the mobile terminal to perform an authentication operation required by the authentication method; and exchanging information with the NFC scanning device according to the information reading request after the authentication operation is verified.

### RELATED APPLICATIONS

This application is a continuation application of PCT Patent Application No. PCT/CN2013/081499, entitled “NFC-BASED INFORMATION EXCHANGE METHOD AND DEVICE” filed on Aug. 14, 2013, which claims priority to Chinese Patent Application No. 201210290523.5, entitled “NFC-BASED INFORMATION EXCHANGE METHOD AND DEVICE”, filed on Aug. 15, 2012, both of which are incorporated by reference in their entirety.

### TECHNICAL FIELD

The disclosed implementations relate generally to the exchange of electronic information. More particularly, the disclosed implementations relate to a Near-Field-Communication-based (NFC) information exchange method and device.

### BACKGROUND

NFC is a contact-less identification and interconnection technology, designed to perform and interact between mobile terminals, consumer electronics products, personal computers and other smart control devices. NFC is inexpensive and easy to use as it allows consumers to exchange information and services effortlessly with a simple touching motion; and it has been widely adopted in many areas, including entrance security, public transits and exchange between mobile phones.

Nonetheless, since the NFC exchange operation is performed closely around several centimeters from a reading-writing instrument—for instance, an exchange of information between a mobile phone and a public transit card swiping system can be performed by simply putting the mobile phone close to the card swiping system—security risks could exist and personal information could become vulnerable to exposure through malicious software (such as fare-stealing Trojans) during such exchange, thereby causing monetary loss.

### SUMMARY

Based on this concern, it is necessary to provide a more secured NFC-based information exchange method.

In accordance with some embodiments, a Near-Field-Communication-based (NFC) information exchange method is performed on a mobile terminal having one or more processors and memory for storing one or more programs to be executed by the one or more processors. The method comprises: in response to an information reading request from an NFC scanning device, detecting whether the NFC scanning device works properly; performing security examination on the mobile terminal when the NFC scanning device works properly; acquiring contextual information associated with the information reading request after completing the security examination; choosing one of pre-set risk levels for the information reading request based on the contextual information; selecting an authentication method corresponding to the chosen risk level; prompting a user of the mobile terminal to perform an authentication operation required by the authentication method; and exchanging information with the NFC scanning device according to the information reading request after the authentication operation is verified.

In accordance with some embodiments, an NFC-supporting mobile terminal comprises one or more processors, memory, and one or more program modules stored in the memory and to be executed by the processor. The one or more program modules include instructions for: in response to an information reading request from an NFC scanning device, detecting whether the NFC scanning device works properly; performing security examination on the mobile terminal when the NFC scanning device works properly; acquiring contextual information associated with the information reading request after completing the security examination; choosing one of pre-set risk levels for the information reading request based on the contextual information; selecting an authentication method corresponding to the chosen risk level; prompting a user of the mobile terminal to perform an authentication operation required by the authentication method; and exchanging information with the NFC scanning device according to the information reading request after the authentication operation is verified.

In accordance with some embodiments, a non-transitory computer readable medium stores one or more program modules in conjunction with an NFC-supporting mobile terminal. The one or more program modules include instructions for: in response to an information reading request from an NFC scanning device, detecting whether the NFC scanning device works properly; performing security examination on the mobile terminal when the NFC scanning device works properly; acquiring contextual information associated with the information reading request after completing the security examination; choosing one of pre-set risk levels for the information reading request based on the contextual information; selecting an authentication method corresponding to the chosen risk level; prompting a user of the mobile terminal to perform an authentication operation required by the authentication method; and exchanging information with the NFC scanning device according to the information reading request after the authentication operation is verified.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a flow chart of an NFC-based information exchange method according to a first embodiment of the present invention;

FIG. 2 is a flow chart of an NFC-based information exchange method according to a second embodiment of the present invention;

FIG. 3 is a flow chart of an NFC-based information exchange method according to some embodiments of the present invention.

FIG. 4 is a schematic diagram of a structural framework of a mobile terminal according to a third embodiment of the present invention;

FIG. 5 is a schematic diagram of a structural framework of a mobile terminal according to a fourth embodiment of the present invention; and

FIG. 6 is a schematic structural diagram of a detection module shown in FIG. 5.

FIG. 7 is a schematic diagram of a structural framework of a mobile terminal according to some embodiments of the present invention.

### DETAILED DESCRIPTION

The following describes technical solutions of an NFC-based information exchange method and system with reference to specific embodiments and the accompanying drawings, so as to make the technical solutions more comprehensible.

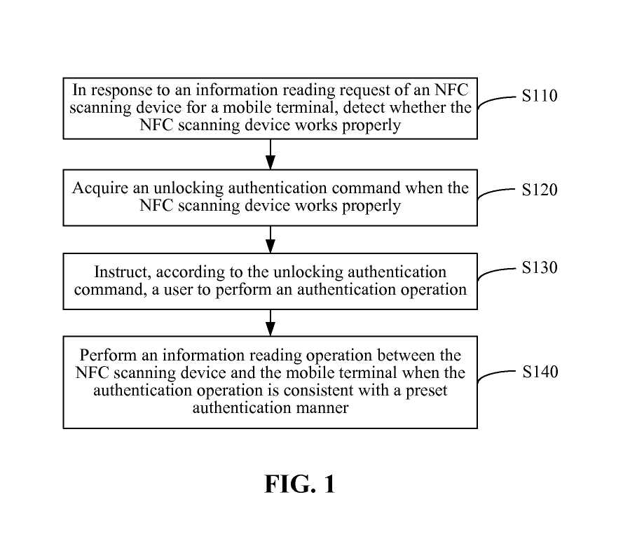

As shown in FIG. 1, in a first embodiment of the present invention, an NFC-based information exchange method includes the following steps:

Step S110: In response to an information reading command by an NFC scanning device to a mobile terminal, detecting whether the NFC scanning device works properly.

Specifically, when a certain kind of information exchange is performed through a mobile terminal with an NFC chip, such as when paying for an item, the mobile terminal detects whether an NFC payment process is to be started manually or has been running on the mobile terminal. By placing the mobile terminal of which the NFC payment process has started near an external NFC scanning device, the scanning device reads the NFC chip on the mobile terminal, and the mobile terminal, in response to the reading command by the scanning device, detects whether the NFC scanning device works properly.

In an embodiment, Step S110 specifically includes: acquiring an identification code on the NFC scanning device; comparing the acquired identification code to a pre-recorded identification code; if they are identical, prompting that the NFC scanning device works properly; and if they are not identical, prompting that the NFC scanning device is not working properly.

Specifically, the identification code on the NFC scanning device is permanently embedded onto the scanning device during manufacture. The pre-recorded identification code is obtained by retrieving from the manufacturer and by recording the embedded identification code onto a server terminal, made downloadable onto the mobile terminal.

After the identification code on the NFC scanning device is acquired and downloaded onto the mobile terminal, the acquired identification code is directly compared to the pre-recorded identification code on the mobile terminal to determine whether they are identical. If they are identical, it is prompted that the NFC scanning device works properly; and if they are not identical, it is prompted that the NFC scanning device is not working properly.

When the identification code on the NFC scanning device is acquired but the mobile terminal fails to download such identification code from the server terminal, the acquired identification code is subsequently uploaded onto the server terminal, which then compares the acquired identification code to the pre-recorded identification code and returns a comparison result to the mobile terminal.

Step S120: Acquiring an unlocking authentication command when the NFC scanning device works properly.

Specifically, the unlocking authentication command may at least include a password command, a gesture command, a fingerprint command or a facial identification command. The password command may be a combination of one or more numbers, letters and symbols. The gesture command refers to a pre-recorded specific gesture, such as a gesture of drawing a circle. The fingerprint command refers to a pre-collected fingerprint. The facial identification command refers to a pre-collected facial image.

Step S130: Instructing, according to the unlocking authentication command, a user to perform an authenticated operation.

Specifically, an unlocking interface is displayed according to the unlocking authentication command, and the user is instructed to perform the authenticated operation on the unlocking interface. The user may be instructed to input with a password, a gesture, a fingerprint or a face. A password may be entered through keys or touching motions; a gesture, fingerprint and a face may be collected through a device such as a camera.

Step S140: Performing an information reading operation between the NFC scanning device and the mobile terminal when the authenticated operation is consistent with a preset authentication method.

Specifically, when the information reading operation is performed between the NFC scanning device and the mobile terminal, such as when payment information is exchanged, the NFC scanning device reads account information on the mobile terminal.

In an embodiment, Step S130 specifically includes: acquiring an authentication operation with an unlocking authentication command--such as a password command, gesture command, fingerprint command and facial identification command—and comparing the authentication operation to a preset corresponding authentication method. Specifically, when an unlocking authentication command is a password command, the authentication operation acquires for a password input, and the acquired password is compared to a pre-recorded password. If they are identical, it is prompted that the matching succeeds; and if they are not identical, it is prompted that the matching fails.

When the unlocking authentication command is a gesture command, a gesture command is collected and compared to a pre-collected gesture command. If they are identical, it is prompted that the matching succeeds; and if they are not identical, it is prompted that the matching fails.

When the unlocking authentication command is a fingerprint command, a fingerprint command is collected and compared to a pre-collected fingerprint command. If they are identical, it is prompted that the matching succeeds; and if they are not identical, it is prompted that the matching fails.

When the unlocking authentication command is a facial identification command, a facial recognition command is collected and compared to a pre-collected facial command. If they are identical, it is prompted that the matching succeeds; and if they are not identical, it is prompted that the matching fails.

When the unlocking authentication command includes a single password command, gesture command, fingerprint command or facial identification command, and when the matching between the authentication operation and the preset authentication method succeeds, the information reading operation between the NFC scanning device and the mobile terminal is performed. When the unlocking authentication command includes a combination of at least two unlocking authentication commands between a password command, a gesture command, a fingerprint command and a facial identification command, and when the matching between at least two authentication operations and the corresponding preset authentication methods succeed, the information reading operation between the NFC scanning device and the mobile terminal is performed.

In addition, the unlocking authentication command may be a combination of several commands, for example, a combination of the password command and the gesture command, where only when the password command is entered and matched successfully, followed by the gesture command being entered and matched successfully, would the information reading operation then be performed.

Further, in an embodiment, before Step S110, the NFC-based information exchange method further includes steps of: pre-setting a permission level of the information reading operation, and setting a corresponding unlocking authentication command combination according to the permission level of the information reading operation, where the unlocking authentication command combination is a combination of at least two of a password command, a gesture command, a fingerprint command and a facial identification command.

Specifically, different permission levels of the information reading operation may be set—for example, 1M (megabyte) data may be exchanged on the first permission level, 10M data may be exchanged on the second permission level, and 100M data may be exchanged on the third permission level—and different unlocking authentication commands may be set according to each corresponding permission level. For example, the unlocking authentication command of the first permission level may be a password command; the unlocking authentication command of the second permission level may be a password command plus a gesture command; and the unlocking authentication command of the third permission level may be a combination of a password command, a gesture command and a fingerprint command.

With respect to the NFC-based information exchange method, in response to the information reading command by the NFC scanning device, it is first detected whether the NFC scanning device works properly. When the NFC scanning device works properly, the unlocking authentication command is acquired, and the user is instructed, according to the unlocking authentication command, to perform the authentication operation. When the authentication operation is consistent with the preset authentication method, the information reading operation is performed between the NFC scanning device and the mobile terminal, thereby protecting from counterfeit NFC scanning devices and heightening security for exchange of information.

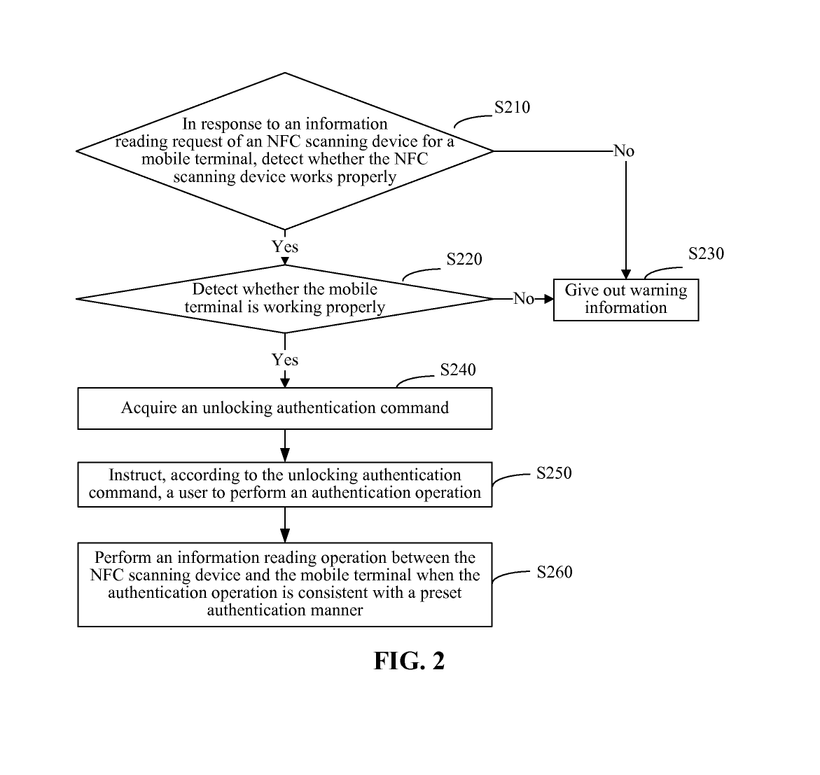

As shown in FIG. 2, in an embodiment, an NFC-based information exchange method includes the following steps:

Step S210: In response to an information reading command by an NFC scanning device to a mobile terminal, detecting whether the NFC scanning device works properly; if yes, execute Step S220, and if not, execute Step S230.

Step S220: Detecting whether the mobile terminal is working properly; if yes, execute Step S240, and if not, execute Step S230.

In an embodiment, Step S220 specifically includes: scanning software installed in the mobile terminal, and comparing the scanned software with pre-stored malicious software; if they are identical, prompting that the malicious software exists, and if not, prompting that no malicious software exists.

Specifically, a program for scanning malicious software is installed on the mobile terminal, and the malicious software is pre-stored on the mobile terminal. When detecting whether the NFC scanning device works properly, the scanning program may start to scan the mobile terminal to determine whether the malicious software exists. The malicious software refers to automatic fare-stealing software, password-stealing software, or the like. When the malicious software exists or when the NFC scanning device is not working properly, warning information is given.

Step S230: Giving warning information.

Specifically, the warning information may be a hazard symbol, or words prompting insecure threats or the like.

Step S240: Acquiring an unlocking authentication command.

Step S250: Instructing, according to the unlocking authentication command, a user to perform an authenticated operation.

Step S260: Performing an information reading operation between the NFC scanning device and the mobile terminal when the authentication operation is consistent with a preset authentication method.

With respect to the NFC-based information exchange method, in response to the reading command of the NFC scanning device, it is first detected whether the NFC scanning device works properly. When the NFC scanning device works properly, it is further detected whether the mobile terminal is working properly. When the mobile terminal is working properly, the unlocking authentication command is acquired, and the user is instructed, according to the unlocking authentication command, to perform the authentication operation. When the authentication operation is consistent with the preset authentication method, the information reading operation is performed between the NFC scanning device and the mobile terminal, thereby protecting the use of mobile terminal from counterfeit NFC scanning devices, which further heightens security of exchange of information.

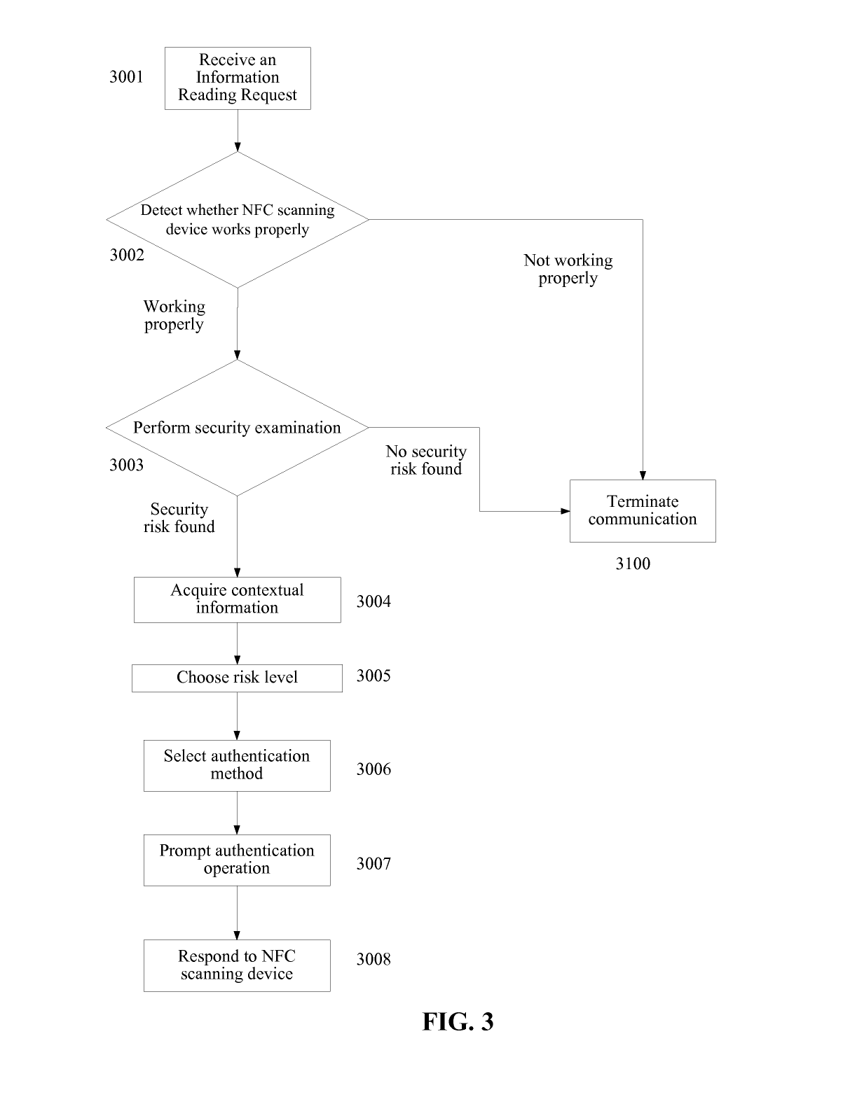

FIG. 3 is a flow chart of an NFC-based information exchange method according to some embodiments of the present invention. The method is performed on a mobile terminal having one or more processors and memory for storing one or more programs to be executed by the one or more processors. The method comprises: in response to an information reading request from an NFC scanning device, detecting whether the NFC scanning device works properly; performing security examination on the mobile terminal when the NFC scanning device works properly; acquiring contextual information associated with the information reading request after completing the security examination; choosing one of pre-set risk levels for the information reading request based on the contextual information; selecting an authentication method corresponding to the chosen risk level; prompting a user of the mobile terminal to perform an authentication operation required by the authentication method; and exchanging information with the NFC scanning device according to the information reading request after the authentication operation is verified.

In step 3001, a mobile terminal receives an information reading request from an NFC scanning device.

In step 3002, in response to an information reading request from an NFC scanning device, the mobile terminal detects whether the NFC scanning device works properly. There are various ways to detect whether the NFC scanning device works properly, which can be employed either singly or in combination with others.

First, the mobile terminal may examine whether the NFC scanning device has a proper identification code as illustrated in step S110 of FIG. 1. Every NFC scanning device is assigned with a unique identification code which is stored in the device. The identification code of the NFC scanning device may be registered in some regulation organizations. The mobile terminal may request the NFC scanning device to send the identification code. Upon acquiring a correct identification code, the mobile terminal may determine that the NFC scanning device is a legitimate device. If no identification code is received, or the identification code is wrong, the mobile terminal may determine that the NFC scanning device is not working properly.

Second, the mobile terminal may examine whether the NFC scanning device has timely updated its software. After receiving the information reading request from the NFC scanning device, the mobile terminal may send an information reading request to the NFC as well. The information reading request contains a request for a summary of the updating of applications and the security examination of the NFC scanning device. If the version of an application is old or the NFC scanning device has not performed the security examination for a long time, the mobile terminal may determine that the NFC is not working properly.

Third, the mobile terminal may determine whether the electromagnetic field is normal. In the process of sending an information reading request, the NFC scanning device usually establishes an electromagnetic field between the NFC scanning device and the mobile terminal. The mobile terminal may require that the signal-to-noise ratio in the field provided by the NFC scanning device to be above a certain threshold level to determine that the NFC scanning device works properly. A low signal-to-noise level may suggest that there is another electronic device nearby, which may pose risks to the communication.

Fourth, the mobile terminal may determine whether the communication from the NFC scanning device complies with certain industry standards. The mobile terminal may examine whether the information reading request conforms to a predefined industry standard in regard to modulation schemes, coding, transfer speeds and frame format of the RF interface of NFC devices, etc.

Fifth, the mobile terminal may examine the consistency of the information reading request and the type of the NFC scanning device. For example, if judging by the identification code, the mobile terminal determines that the NFC scanning device is used for controlling a gate and yet the information reading request contains a request for payment. The mobile terminal should find that the NFC scanning device is not working properly when finding such inconsistency between the information reading request and the type of the NFC scanning device.

If the NFC scanning device is found not working properly, the mobile device jumps to step 3100 to terminate the communication with the NFC scanning device and prompt the user for security risk.

In step 3003, if the mobile terminal determines that the NFC scanning device works properly, the mobile terminal performs security examination on the mobile terminal itself. The security examination may include an updating review on every application regarding the time of the last update. The mobile terminal acquires a timestamp of the last security examination on an application, calculates length of time that has elapsed after the acquired timestamp, and detects malicious software in the application when the length of time exceeds a predefined amount. For if the application has been examined by security software within one day, the security programs do not have to examine it again. In this way, the security programs save time by not having to detect malicious software in every application.

In addition, the mobile terminal may determine which application is to be used to process the information reading request. The security examination may emphasize on the to-be-used application and other related applications so that to use time more strategically.

Also, for the sake of efficiency, any method of quick scanning of the mobile terminal may be employed. There is a balance of performing a comprehensive security examination and reducing the time devoted so as to not cause inconvenience to the user.

If the security examination reveals any security risk, the mobile device jumps to step 3100 to terminate the communication with the NFC scanning device and prompt the user for security risk.

In step 3004, the mobile device acquires contextual information associated with the information reading request after completing the security examination if no security risk is found. The contextual information includes one or more selected from the group consisting of a location of the mobile terminal, a purpose of the information reading request, past history of communicating with the NFC scanning device, an amount of data requested to be exchanged and a type of the NFC scanning device. The contextual information may be acquired through various means available to the mobile device. For example, the location of the mobile terminal can be acquired through either GPS or mobile positioning with radio signals.

In step 3005, the mobile device chooses one of pre-set risk levels for the information reading request based on the contextual information and a first set of pre-set criteria. The first set of pre-set criteria may be applied by an algorithm which chooses a risk level based on a plurality of inputs from the contextual information. For example, the risk levels may include five levels, from the riskiest to the least risky. The criteria may include multiple considerations of the security of the particular information reading request. For example, if the location of the mobile terminal is outside of its normal location scope, the risk level may go up. In addition, if the purpose of the information reading request is to open a security box, the risk level may be higher than when the purpose is to pay for $2 for a bus trip. Also, when the purpose of the information reading request is to start a payment transaction, the contextual information may also include an amount of payment. Further, certain types of NFC scanning device may also be deemed as riskier than others. For example, one NFC scanning device may comply with a higher safety standard than another one. At last, if the NFC scanning device has been communicating with the mobile terminal in the past, the mobile terminal may adjust the risk level to be lower. In some embodiments, the user of the mobile terminal may be able to change the first set of pre-set criteria.

In step 3006, the mobile terminal selects an authentication method corresponding to the chosen risk level based on a second set of pre-set criteria. A mobile terminal often has more than one authentication method, including inputting passwords, connecting dots, scanning fingerprints, detecting gesture, voice identification, face identification, answering questions, etc. Authentication methods have inherent risks, some riskier than others. Often, the simpler authentication method is also the riskier one. The second set of pre-set criteria contains the corresponding relationships between authentication methods and pre-set risk levels. A higher risk level may correspond to a safer authentication method (which may also be more complicated and time-consuming). In accordance with some embodiments, the user of the mobile device can change the corresponding relationships contained in the second set of pre-set criteria. The user can also set preferred authentication method corresponding to a particular risk level. In some embodiments, the mobile terminal has at least two authentication methods corresponding to different risk levels.

In step 3007, after the authentication method is selected, the mobile terminal prompts a user of the mobile terminal to perform an authentication operation required by the authentication method. A person skilled in the art would know that authentication methods require different authentication operations. More detailed descriptions of performing an authentication operation can be found in descriptions of step S130 in FIG. 1.

In step 3008, after the authentication operation is verified, the mobile device responds to the NFC scanning device according to the information reading request. The mobile device then exchanges information with the NFC scanning device as demanded by the information reading request.

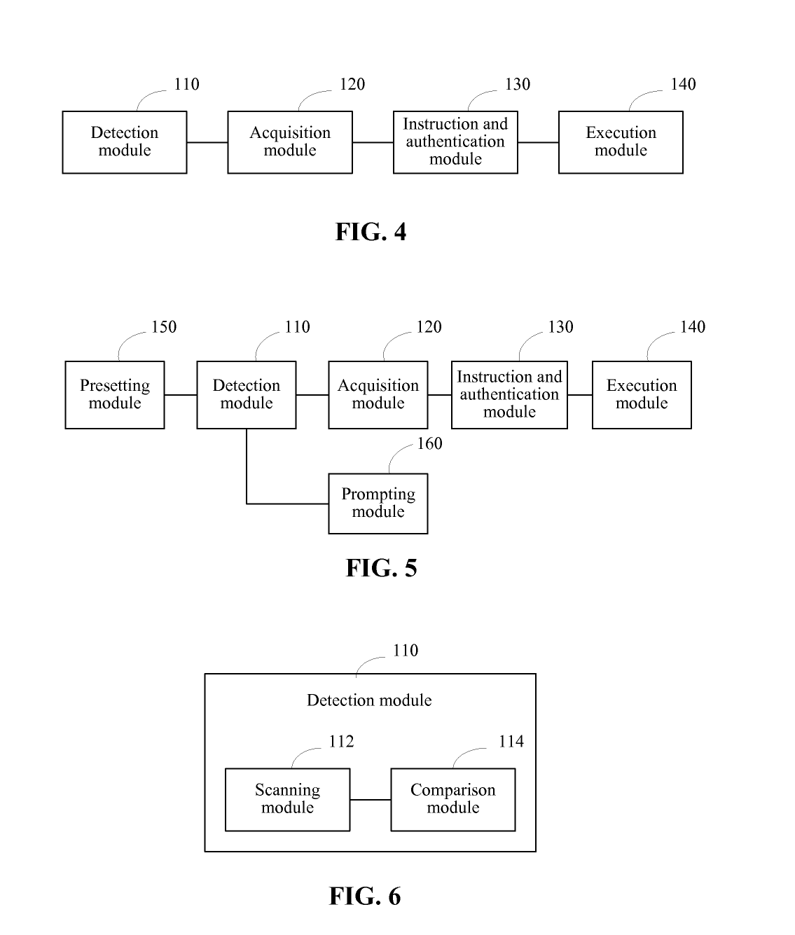

As shown in FIG. 4, in an embodiment, an NFC-based information exchange device includes: a detection module 110, an acquisition module 120, an instruction and authentication module 130 and an execution module 140.

The detection module 110 is configured to, in response to an information reading command by an NFC scanning device to a mobile terminal, detect whether the NFC scanning device works properly.

Specifically, when a certain kind of information exchange is performed through a mobile terminal with an NFC chip, such as when paying for an item, the mobile terminal detects whether an NFC payment process is to be started manually or has been running on the mobile terminal. By placing the mobile terminal of which the NFC payment process has started near an external NFC scanning device, the scanning device reads the NFC chip on the mobile terminal, and the detection module 110 on the mobile terminal, in response to the reading command by the scanning device, detects whether the NFC scanning device works properly.

The acquisition module 120 is configured to acquire an unlocking authentication command when it has detected that the NFC scanning device works properly.

Specifically, the unlocking authentication command may at least include a password command, a gesture command, a fingerprint command or a facial identification command. The password command may be a combination of one or more numbers, letters and symbols. The gesture command refers to a pre-recorded specific gesture, such as a gesture of drawing a circle. The fingerprint command refers to a pre-collected fingerprint. The facial identification command refers to a pre-collected facial image.

The instruction and authentication module 130 is configured to instruct, according to the unlocking authentication command, a user to perform an authentication operation.

Specifically, an unlocking interface is displayed according to the unlocking authentication command, and the user is instructed to perform the authentication operation on the unlocking interface. The user may be instructed to input with a password, a gesture, a fingerprint or a face. A password may be entered through keys or touching motions; a gesture, fingerprint and a face may be collected through a device such as a camera.

The execution module 140 is configured to perform an information reading operation between the NFC scanning device and the mobile terminal when the authentication operation is consistent with a preset authentication method.

Specifically, when the information reading operation is performed between the NFC scanning device and the mobile terminal, such as when payment information is exchanged, the NFC scanning device reads account information on the mobile terminal.

The instruction and authentication module 130 is configured to acquire an authentication operation with an unlocking authentication command—such as a password command, gesture command, fingerprint command and facial identification command—and to compare the acquired authentication operation to a preset corresponding authentication method.

Specifically, when the unlocking authentication command is a password command, the instruction and authentication module 130 acquires for a password input, and the acquired password is compared to a pre-stored password; if they are identical, it is prompted that the matching succeeds, and if they are not identical, it is prompted that the matching fails.

When the unlocking authentication command is a gesture command, the instruction and authentication module 130 acquires for a gesture input, and the acquired gesture is compared to a pre-stored gesture command; if they are identical, it is prompted that the matching succeeds, and if they are not identical, it is prompted that the matching fails.

When the unlocking authentication command is a fingerprint command, the instruction and authentication module 130 acquires for a fingerprint command, and the acquired fingerprint is compared to a pre-stored fingerprint command; if they are identical, it is prompted that the matching succeeds, and if they are not identical, it is prompted that the matching fails.

When the unlocking authentication command is a facial identification command, the instruction and authentication module 130 acquires for a facial command, and the acquired facial input is compared to a pre-stored facial command; if they are identical, it is prompted that the matching succeeds, and if they are not identical, it is prompted that the matching fails.

When the unlocking authentication command includes a single password command, gesture command, fingerprint command or facial identification command, and when the matching by the instruction and authentication module 130 between the authentication operation and the preset authentication method succeeds, the execution module 140 performs the information reading operation between the NFC scanning device and the mobile terminal. When the unlocking authentication command includes a combination of at least two unlocking authentication commands between a password command, a gesture command, a fingerprint command and a facial identification command, and when at least two matching between the authentication operations and the corresponding preset authentication methods succeed, the execution module 140 performs the information reading operation between the NFC scanning device and the mobile terminal.

In addition, the unlocking authentication command may be a combination of several commands, for example, a combination of the password command and the gesture command, where only when the password command is entered and matched successfully, followed by the gesture comment being entered and matched successfully, would the information reading operation then be performed.

With respect to the NFC-based information exchange system, in response to the information reading command by the NFC scanning device, it is first detected whether the NFC scanning device works properly. When the NFC scanning device works properly, the unlocking authentication command is acquired, and the user is instructed, according to the unlocking authentication command, to perform the authentication operation. When the authentication operation is consistent with the preset authentication method, the information reading operation is performed between the NFC scanning device and the mobile terminal, thereby protecting the use of mobile terminal from counterfeit NFC scanning devices, which further heightens security of exchange of information.

As shown in FIG. 5, in an embodiment, in addition to the detection module 110, the acquisition module 120, the instruction and authentication module 130 and the execution module 140, the mobile terminal further includes a prompting module 150 and a presetting module 160.

The prompting module 150 is configured to give out warning information when the detection module 110 detects that the NFC scanning device is not working properly. Specifically, the warning information may be a hazard symbol, or words prompting insecure threats or the like; thereby alerts the user and heightens security.

The detection module 110 is further configured to further detect whether the mobile terminal is working properly after detecting that the NFC scanning device works properly; if not, the prompting module 150 gives out the warning information, and if yes, the acquisition module 120 acquires the unlocking authentication command.

The presetting module 150 is configured to preset a permission level of the information reading operation, and set a corresponding unlocking authentication command combination according to the permission level of the information reading operation, where the unlocking authentication command combination is a combination of at least two of a password command, a gesture command, a fingerprint command and a facial identification command.

Specifically, different permission levels of the information reading operation may be set—for example, 1M (megabyte) data may be exchanged on the first permission level, 10M data may be exchanged on the second permission level, and 100M data may be exchanged on the third permission level—and different unlocking authentication commands may be set according to each corresponding permission level. For example, the unlocking authentication command of the first permission level may be a password command; the unlocking authentication command of the second permission level may be a password command plus a gesture command; and the unlocking authentication command of the third permission level may be a combination of a password command, a gesture command and a fingerprint command.

As shown in FIG. 6, in an embodiment, the detection module 110 includes a scanning module 112 and a comparison module 114.

A specific process in which the detection module 110 detects whether an NFC scanning device works properly is that:

The scanning module 112 is configured to acquire an identification code of the NFC scanning device. Specifically, the identification code of the NFC scanning device is permanently embedded onto the scanning device during manufacture.

The comparison module 114 is configured to compare the acquired identification code with a pre-recorded identification code; if they are identical, it is prompted that the NFC scanning device works properly, and if they are not identical, it is prompted that the NFC scanning device is not working properly.

Specifically, the pre-recorded identification code is obtained by retrieving from the manufacturer and by recording the embedded identification code onto a server terminal, made downloadable onto the mobile terminal. After the identification code on the NFC scanning device is acquired by the scanning module 112 and downloaded onto the mobile terminal, the comparison module 114 directly compares the acquired identification code with the identification code pre-recorded on the mobile terminal to determine whether they are identical; if they are identical, it is prompted that the NFC scanning device works properly, and if they are not identical, it is prompted that the NFC scanning device is not working properly.

A specific process in which the detection module 110 detects whether the mobile terminal is working properly is that:

The scanning module 112 is configured to scan software installed on the mobile terminal.

The comparison module 114 is configured to compare the scanned software with pre-installed software; if they are identical, it is prompted that malicious software exists, and if they are not identical, it is prompted that no malicious software exists. Specifically, the malicious software is pre-installed on the mobile terminal, and when it detects whether the NFC scanning device works properly, the scanning module 112 scans the mobile device to determine whether the malicious software exists on the mobile terminal. The malicious software refers to the automatic fare-stealing software, the password-steeling software or the like.

In addition to detecting whether the NFC scanning device works properly, the unlocking authentication command is acquired to determine whether the mobile terminal is working properly from malicious password-stealing or fare-stealing software. The unlocking authentication command combination is set according to the permission level of the information reading operation, thereby heightening the security and promptness for exchange of information.

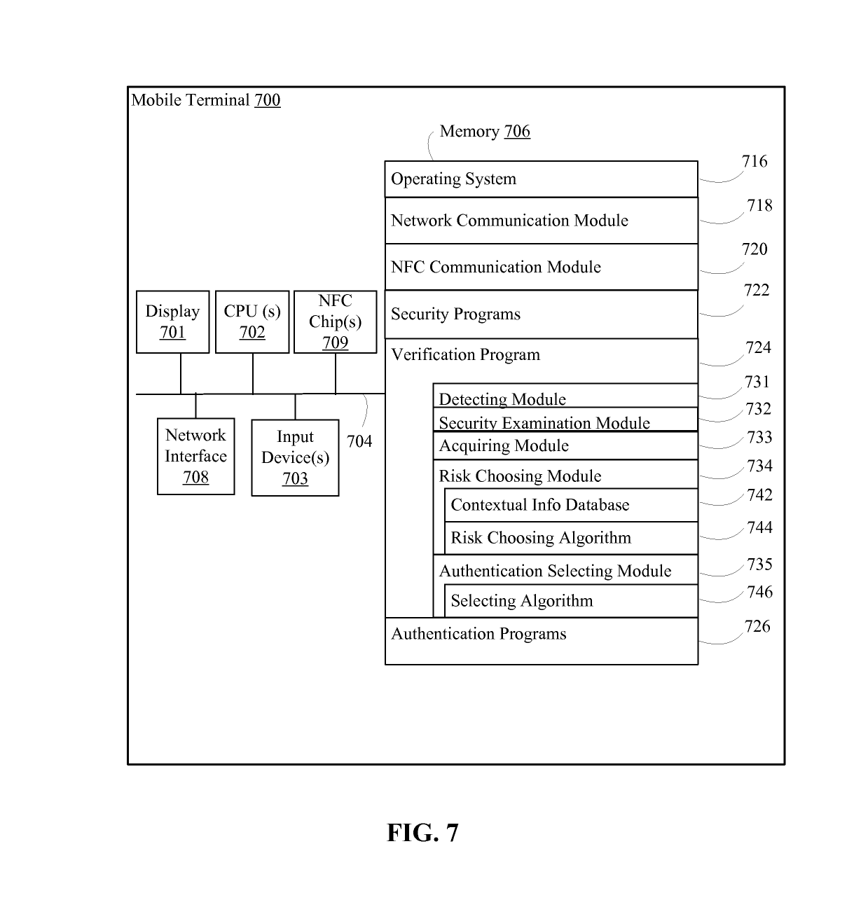

FIG. 7 is a diagram of an example implementation of a mobile terminal 700 (e.g., a mobile phone) in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, the mobile terminal 700 includes one or more processing units (CPU's) 702, one or more network or other communications interfaces 708, one or more NFC chips 709, a display 701, memory 706, and one or more communication buses 704 for interconnecting these and various other components. The communication buses may include circuitry (sometimes called a chipset) that interconnects and controls communications between system components. The memory 706 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 706 may optionally include one or more storage devices remotely located from the CPU(s) 702. The memory 706, including the non-volatile and volatile memory device(s) within the memory 706, comprises a non-transitory computer readable storage medium.

In some implementations, the memory 706 or the non-transitory computer readable storage medium of the memory 706 stores the following programs, modules and data structures, or a subset thereof including an operating system 716, a network communication module 718, an NFC communication module 720, security programs 722, a verification program 724 and authentication programs 726.

The operating system 716 includes procedures for handling various basic system services and for performing hardware dependent tasks.

The network communication module 718 facilitates communication with other devices via the one or more communication network interfaces 708 (wired or wireless) and one or more communication networks, such as the internet, other wide area networks, local area networks, metropolitan area networks, and so on.

The NFC communication module 720 facilitates communication with another NFC supporting device (including an NFC scanning device) or an NFC tag through the one or more NFC chips 709.

The security programs 722 can be any security programs that are configured to be installed on a mobile phone. The security programs 722 are configured to perform security examinations as instructed by the security examination module 732.

The verification program 724 includes a detecting module 731, a security examination module 732, an acquiring module 733, a risk choosing module 734, and an authentication selecting module 735.

The detecting module 731 is configured to detect whether the NFC scanning device works properly through the NFC communication module 718 as illustrated in step 3002 of FIG. 3.

The security examination module 732 is configured to instruct the security programs 722 to perform security examinations as illustrated in step 3003 of FIG. 3. In accordance with some embodiments, the security examination module 732 is configured to specifically instruct the security programs where and how to perform security examination to enhance the efficiency of the examination.

The acquiring module 733 is configured to acquire contextual information associated with the information reading request as illustrated in step 3004 of FIG. 3. A person skilled in the art would understand that the acquiring module 733 acquires contextual information from various sources and may utilize various capacities of the mobile terminal 700 for different types of contextual information.

The risk choosing module 734 is configured to choose one of pre-set risk levels for the information reading request based on the contextual information and the first set of pre-set criteria as illustrated in step 3005 of FIG. 3. The risk choosing module 734 further includes a contextual information database 742 and a risk choosing algorithm 744. The contextual information database may store certain contextual information or any information related to the first set of pre-set criteria, e.g., the past history of communicating with the NFC scanning device, and previous locations of the mobile terminal 700. The risk choosing algorithm includes the first set of pre-set criteria.

The authentication selecting module 735 is configured to select an authentication method corresponding to the chosen risk level based on the second set of pre-set criteria as illustrated in step 3006 of FIG. 3. The authentication selecting module 735 includes a selecting algorithm 746, which includes the second set of pre-set criteria.

Authentication programs 726 may include any authentication program that may be performed on a mobile terminal to identify a user of the mobile terminal.

In addition, the NFC-based information exchange device may be installed on devices such as mobile phones, iPads, personal digital assistant devices, and tablet computers.

With respect to the NFC-based information exchange method and device, in response to the reading command of the NFC scanning device, it is first detected whether the NFC scanning device works properly. When the NFC scanning device works properly, the unlocking authentication command is acquired to complete information exchange, thereby protecting from counterfeit NFC scanning device and heightening security for exchange of information.

Persons of ordinary skill in the art may understand that all or part of the process of the methods in the embodiments may be implemented by a computer program instructing relevant hardware. The program may be stored on a computer readable storage medium. When the program runs, the processes of the methods in the embodiments are performed. The storage medium may be a magnetic disk, an optical disk, a read-only memory (ROM), a random access memory (RAM), or the like.

The embodiments described above only represent several implementation manners of the present invention, and descriptions thereof are specific and detailed, but should not be understood as a limit to the scope of the present invention. It should be pointed out that persons of ordinary skill in the art can make modifications and improvements without departing from the idea of the present invention and these modifications and improvements all belong to the protection scope of the present invention. Therefore, the protection scope of the present invention should be subject to the protection scope of the appended claims.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A Near-Field-Communication (NFC) based information exchange method performed on a mobile terminal having one or more processors and memory for storing one or more programs to be executed by the one or more processors, the method comprising:
in response to an information reading request from an NFC scanning device, detecting whether the NFC scanning device works properly;
performing security examination on the mobile terminal when the NFC scanning device works properly;
acquiring contextual information associated with the information reading request after completing the security examination;
choosing one of pre-set risk levels for the information reading request based on the contextual information;
selecting an authentication method corresponding to the chosen risk level;
prompting a user of the mobile terminal to perform an authentication operation required by the authentication method; and
exchanging information with the NFC scanning device according to the information reading request after the authentication operation is verified.

2. The method of claim 1, wherein the contextual information includes one or more selected from the group consisting of a location of the mobile terminal, a purpose of the information reading request, past history of communicating with the NFC scanning device, an amount of data requested to be exchanged and a type of the NFC scanning device.

3. The method of claim 2, wherein when the purpose of the information reading request is to start a payment transaction, the contextual information also includes an amount of payment.

4. The method of claim 1, wherein the mobile terminal has at least two authentication methods corresponding to different risk levels and the authentication operation is performed by executing two or more of the two authentication methods in parallel or in a series.

5. The method of claim 1, wherein detecting whether the NFC scanning device works properly comprises:
examining whether signal of the information reading request conforms to a predefined industry standard.

6. The method of claim 1, wherein detecting whether the NFC scanning device works properly comprises:
examining the consistency of the information reading request and the type of the NFC scanning device.

7. The method of claim 1, wherein detecting whether the NFC scanning device works properly comprises:
detecting a signal-to-noise ratio within a field close to the NFC scanning device.

8. The method of claim 1, wherein detecting whether the NFC scanning device works properly comprises:
acquiring an identification code that is stored in the NFC scanning device.

9. The method of claim 1, wherein performing security examination comprises:
acquiring a timestamp of the last security examination on an application;
calculating length of time that has elapsed after the acquired timestamp; and
detecting malicious software in the application when the length of time exceeds a predefined amount.

10. An NFC-supporting mobile terminal, comprising:
one or more processors;
memory; and
one or more program modules stored in the memory and to be executed by the processors, the one or more program modules including instructions for:
in response to an information reading request from an NFC scanning device, detecting whether the NFC scanning device works properly;
performing security examination on the mobile terminal when the NFC scanning device works properly;
acquiring contextual information associated with the information reading request after completing the security examination;
choosing one of pre-set risk levels for the information reading request based on the contextual information;
selecting an authentication method corresponding to the chosen risk level;
prompting a user of the mobile terminal to perform an authentication operation required by the authentication method; and
exchanging information with the NFC scanning device according to the information reading request after the authentication operation is verified.

11. The mobile terminal of claim 10, wherein the contextual information includes one or more selected from the group consisting of a location of the mobile terminal, a purpose of the information reading request, past history of communicating with the NFC scanning device, an amount of data requested to be exchanged and a type of the NFC scanning device.

12. The mobile terminal of claim 11, wherein when the purpose of the information reading request is to start a payment transaction, the contextual information also includes an amount of payment.

13. The mobile terminal of claim 10, wherein the mobile terminal has at least two authentication methods corresponding to different risk levels and the authentication operation is performed by executing two or more of the two authentication methods in parallel or in a series.

14. The mobile terminal of claim 10, wherein detecting whether the NFC scanning device works properly comprises:
examining whether signal of the information reading request conforms to a predefined industry standard.

15. The mobile terminal of claim 10, wherein detecting whether the NFC scanning device works properly comprises:
examining the consistency of the information reading request and the type of the NFC scanning device.

16. The mobile terminal of claim 10, wherein detecting whether the NFC scanning device works properly comprises:
detecting a signal-to-noise ratio within a field close to the NFC scanning device.

17. The mobile terminal of claim 10, wherein detecting whether the NFC scanning device works properly comprises:
acquiring an identification code that is stored in the NFC scanning device.

18. The mobile terminal of claim 10, wherein performing security examination comprises:
acquiring a timestamp of the last security examination on an application;
calculating length of time that has elapsed after the acquired timestamp; and
detecting malicious software in the application when the length of time exceeds a predefined amount.

19. A non-transitory computer readable medium storing one or more program modules in conjunction with a NFC-supporting mobile terminal including one or more processors for executing the program modules, the program modules including instructions for:
in response to an information reading request from an NFC scanning device, detecting whether the NFC scanning device works properly;
performing security examination on the mobile terminal when the NFC scanning device works properly;
acquiring contextual information associated with the information reading request after completing the security examination;
choosing one of pre-set risk levels for the information reading request based on the contextual information;
selecting an authentication method corresponding to the chosen risk level;
prompting a user of the mobile terminal to perform an authentication operation required by the authentication method; and
exchanging information with the NFC scanning device according to the information reading request after the authentication operation is verified.

20. The computer readable medium of claim 19, wherein performing security examination comprises:
acquiring a timestamp of the last security examination on an application;
calculating length of time that has elapsed after the acquired timestamp; and
detecting malicious software in the application when the length of time exceeds a predefined amount.
